(19) United States
(12) Patent Application Publication
(10) Pub. No.: US 2024/0353620 A1
(43) Pub. Date: Oct. 24, 2024

(54) MODE CONVERTER, MODE CONVERSION DEVICE AND OPTICAL DEVICE

(71) Applicant: Nippon Telegraph and Telephone Corporation, Tokyo (JP)

(72) Inventors: Masaaki Ono, Tokyo (JP); Akihiko Shinya, Tokyo (JP); Masaya Notomi, Tokyo (JP)

(21) Appl. No.: 18/682,733

(22) PCT Filed: Aug. 25, 2021
(86) PCT No.: PCT/JP2021/031124

§ 371 Date: Feb. 9, 2024

(51) Int. Cl. G02B 6/14; G02B 6/122

(52) U.S. Cl. CPC G02B 6/14; G02B 6/1228

(57) ABSTRACT

In a mode converter, light is input from a dielectric waveguide having a tapered structure and output to an MIM waveguide. The mode converter includes: a substrate; a first metal layer on the substrate; an insulator layer continuously covering a part of an upper surface of the substrate and a part of a side surface and a part of an upper surface of the first metal layer; and a second metal layer continuously covering from a part of the insulator layer covering the upper surface of the substrate to a part of the insulator layer covering the first metal layer, in which light propagates through a region of the insulator layer sandwiched between the first metal layer and the second metal layer, and the region increases from an input part toward an output part.

### CROSS-REFERENCE TO RELATED APPLICATIONS

This application is a national phase entry of PCT Application No. PCT/JP2021/031124, filed on Aug. 25, 2021, which application is hereby incorporated herein.

### TECHNICAL FIELD

The present invention relates to a mode converter having an MIM waveguide structure, a mode conversion device, and an optical device.

### BACKGROUND

In recent years, it has been studied to solve the problems of energy consumption, heat generation, and delay in electronic circuits by integration of optical circuits. However, optical elements in conventional optical circuits have a large size and large energy consumption, and are not suitable for high-density integration. Energy consumption in an optical element is generally limited by its size, and miniaturization leads to low energy consumption. Therefore, achievement of an ultra-small optical element is a key to low energy consumption by integration of optical circuits. Therefore, a plasmonic waveguide whose size is not limited by the diffraction limit of light has attracted attention.

The plasmonic waveguide is formed from a single or multiple metal-dielectric interface. Since light propagates as a near field at an interface between a metal and a dielectric, the light confinement size decreases as the size decreases even in the region below the diffraction limit. Therefore, it is expected as a platform for efficiently interacting with light and a substance in a nanometer size, and nanomaterials such as nanowires and two-dimensional layered materials have attracted attention as target substances.

In particular, a two-dimensional layered substance represented by graphene has unique physical properties, and introduction thereof is expected to lead not only to reduction in energy consumption and size, but also to novel optical elements beyond the framework of existing optical elements.

On the other hand, since the plasmonic waveguide has a large propagation loss due to absorption of light by metal, it is difficult to configure an optical circuit only with the plasmonic waveguide. Therefore, it is important to use a plasmonic waveguide only in a portion where interaction between a nanomaterial or the like and light is required, and to use a low-loss dielectric waveguide (silicon waveguide or the like) for long-range light propagation.

Patent Literature 1 discloses a highly efficient mode converter in which a plasmonic waveguide and a dielectric waveguide are coupled, the plasmonic waveguide and the dielectric waveguide being greatly different in shape and size of propagation modes. In addition, using this configuration, an ultra-high speed and low energy consumption all-optical switch in which graphene and a plasmonic waveguide are combined has been achieved in a state of being coupled to a silicon waveguide (Non Patent Literature 1). This demonstrates that plasmonic waveguides are suitable platforms for achieving an ultrafast optical element using nanomaterials.

In plasmonic waveguide-based optical elements conventionally reported including the above-described all-optical switch, a lateral metal-insulator-metal (MIM) waveguide having an MIM structure in a substrate in-plane direction (lateral direction) has been used (Non Patent Literatures 1 and 2). However, in many lateral MIM waveguides, nanofabrication techniques such as resist pattern formation by electron beam drawing are used to manufacture metal portions, and it is difficult to set the width of the insulator layer serving as the waveguide core to about 10 nm or 10 nm or less due to limitations in manufacturing.

On the other hand, the vertical MIM waveguide having the MIM structure in the direction (vertical direction) perpendicular to the substrate surface is manufactured by forming a film of a metal, an insulator, and a metal on the substrate. In a vapor deposition device and a sputtering device, since the film formation thickness can be controlled with nanometer-precision, a very thin insulator layer, that is, a waveguide core can be manufactured. In principle, it is also possible to manufacture an insulator layer having a single atomic thickness by using an atomic layer deposition device or a two-dimensional layered material. Therefore, in the vertical MIM waveguide, extreme optical confinement is expected.

### CITATION LIST

### Patent Literature

Patent Literature 1: JP 2014-170126 A

### Non Patent Literature

Non Patent Literature 1: M. Ono, M. Hata, M. Tsunekawa, K. Nozaki, H. Sumikura, H. Chiba, M. Notomi, “Ultrafast and energy-efficient all-optical switching with graphene-loaded deep-subwavelength plasmonic waveguides”, Nature Photonics 14, 37 (2020).

Non Patent Literature 2: A. Melikyan, L. Alloatti, A. Muslija, D. Hillerkuss, P. C. Schindler, J. Li, R. Palmer, D. Korn, S. Muehlbrandt, D. Van Thourhout, B. Chen, R. Dinu, M. Sommer, C. Koos, M. Kohl, W. Freude, and J. Leuthold, “High-speed plasmonic phase modulators”, Nature Photonics 8, 229 (2014).

Non Patent Literature 3: R. Yang, M. A. G. Abushagur, and Z. Lu, “Efficiently squeezing near infrared light into a 21nm-by-24nm nanospot”, Optics Express 16, 20142 (2008).

Non Patent Literature 4: H. Choo, M.-K. Kim, M. Staffaroni, T. J. Seok, J. Bokor, S. Cabrini, P. J. Schuck, M. C. Wu, and E. Yablonovitch, “Nanofocusing in a metal-insulator-metal gap plasmon waveguide with a three-dimensional linear taper”, Nature Photonics 6, 838 (2012).

### SUMMARY

### Technical Problem

In order to input light to a vertical MIM waveguide in which an oscillation direction of an electric field is a vertical direction, a method of coupling TM modes in a dielectric waveguide using butt coupling has been proposed (Non Patent Literature 3). In this method, in order to concentrate light on an insulator layer serving as a core of the MIM waveguide, it is necessary to avoid propagation of light to an upper surface of an upper layer metal and an interface between a lower layer metal and a substrate in the MIM waveguide. Therefore, it is necessary to reduce a component of a side lobe by increasing the height of the dielectric waveguide, and further to make the height of the entire MIM waveguide equal to or higher than the height of the dielectric waveguide.

However, it is difficult to arrange the structures having the above-described heights in proximity to each other, and highly efficient mode conversion has not been achieved.

In order to highly efficiently couple TM modes in the vertical MIM waveguide and the dielectric waveguide, it is considered that a vertical tapered structure is effective.

However, although the tapered structure in the vertical direction itself can be achieved, coupling to the dielectric waveguide is difficult and has not been achieved. Since the manufacturing involves a complicated manufacturing process, it is difficult to utilize for the optical element in consideration of integration (Non Patent Literature 4).

### Solution to Problem

In order to solve the problem as described above, a mode converter according to embodiments of the present invention is a mode converter in which light is input from a dielectric waveguide having a tapered structure and output to an MIM waveguide, the mode converter including: a substrate; a first metal layer on the substrate; an insulator layer continuously covering a part of an upper surface of the substrate and at least a part of a side surface and at least a part of an upper surface of the first metal layer; and a second metal layer continuously covering from at least a part of the insulator layer covering the upper surface of the substrate to at least a part of the insulator layer covering the first metal layer, in which light propagates through a region of the insulator layer sandwiched between the first metal layer and the second metal layer, the region increases in a predetermined region from an input part to which the light is input toward an output part from which the light is output, the input part is in proximity to a distal end portion of the tapered structure, and each of a side surface of the first metal layer and the insulator layer and a side surface of the insulator layer and the second metal layer on a side of the input part is substantially parallel to and in proximity to a side surface of the tapered structure.

### Advantageous Effects of Embodiments of Invention

According to embodiments of the present invention, it is possible to provide a mode converter, a mode conversion device, and an optical device capable of highly efficiently coupling a dielectric waveguide and an MIM waveguide.

### BRIEF DESCRIPTION OF THE DRAWINGS

FIG. 1 is a schematic bird's-eye view illustrating a configuration of a mode converter according to a first embodiment of the present invention.

FIG. 2A is a schematic top view illustrating a configuration of a mode converter according to the first embodiment of the present invention.

FIG. 2B is a schematic front cross-sectional view illustrating a configuration of the mode converter according to the first embodiment of the present invention taken along line IIB-IIB′.

FIG. 2C is a schematic front cross-sectional view illustrating a configuration of the mode converter according to the first embodiment of the present invention taken along line IIC-IIC′.

FIG. 2D is a schematic front cross-sectional view illustrating a configuration of the mode converter according to the first embodiment of the present invention taken along line IID-IID′.

FIG. 3 is a diagram for explaining an operation of the mode converter according to the first embodiment of the present invention.

FIG. 4A is a diagram for explaining an operation of the mode converter according to the first embodiment of the present invention.

FIG. 4B is a diagram for explaining an operation of the mode converter according to the first embodiment of the present invention.

FIG. 4C is a diagram for explaining an operation of the mode converter according to the first embodiment of the present invention.

FIG. 4D is a diagram for explaining an operation of the mode converter according to the first embodiment of the present invention.

FIG. 4E is a diagram for explaining an operation of the mode converter according to the first embodiment of the present invention.

FIG. 4F is a diagram for explaining an operation of the mode converter according to the first embodiment of the present invention.

FIG. 4G is a diagram for explaining an operation of the mode converter according to the first embodiment of the present invention.

FIG. 4H is a diagram for explaining an operation of the mode converter according to the first embodiment of the present invention.

FIG. 5 is a schematic bird's-eye view illustrating a modification of the mode converter according to the first embodiment of the present invention.

FIG. 6 is a schematic bird's-eye view illustrating a modification of the mode converter according to the first embodiment of the present invention.

FIG. 7 is a schematic top view illustrating a modification of the mode converter according to the first embodiment of the present invention.

FIG. 8 is a schematic top view illustrating an example configuration of an optical device according to a second embodiment of the present invention.

### DETAILED DESCRIPTION OF ILLUSTRATIVE EMBODIMENTS

### First Embodiment

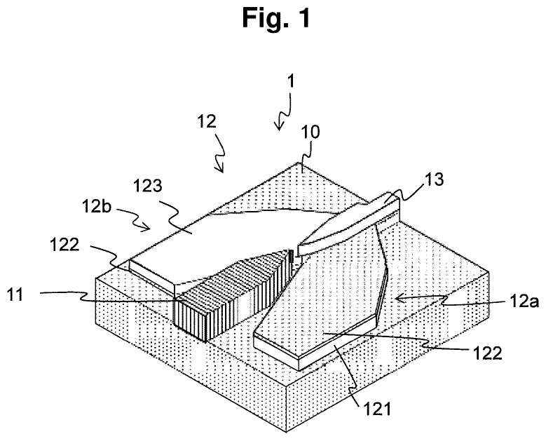

A mode converter and a mode conversion device according to a first embodiment of the present invention will be described with reference to FIGS. 1 to 4H.

### Configuration of Mode Converter and Mode Conversion Device

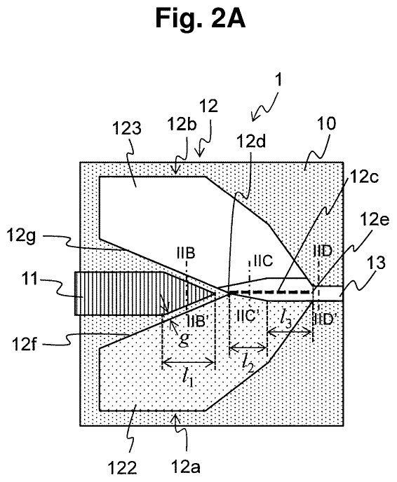

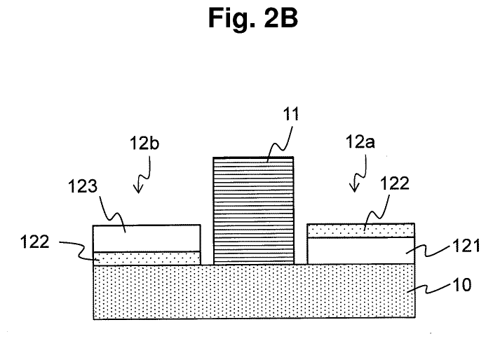

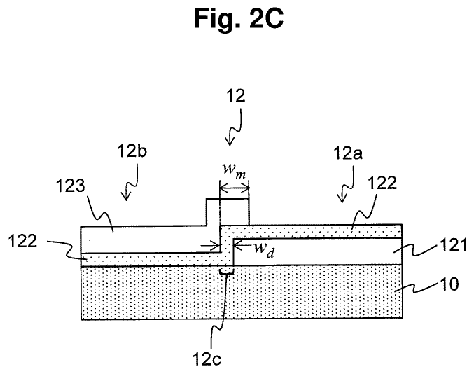

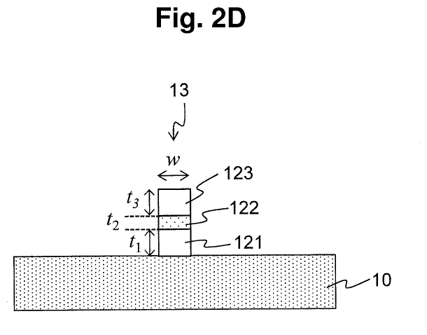

As illustrated in FIGS. 1 and 2A, a mode conversion device 1 according to the present embodiment includes a dielectric waveguide 11, a mode converter 12, and an MIM waveguide 13 on a substrate 10. The dielectric waveguide 11 is disposed on an input side of the mode converter 12, and the MIM waveguide 13 is disposed on an output side of the mode converter 12. As described above, the light is input to the mode converter 12 from the dielectric waveguide 11 and output to the MIM waveguide 13.

An example in which a SiO₂ substrate is used as the substrate 10 is illustrated, but the substrate is not limited thereto, and it is sufficient that a material having a refractive index lower than that of the material of the dielectric waveguide 11 is used. The substrate 10 may be an SOI substrate or a Si substrate having SiO₂ on the surface.

The dielectric waveguide 11 propagates the TE mode light. For example, at a wavelength of 1550 nm, a Si fine wire waveguide having a core size of 400 nm in width×200 nm in height is used.

The dielectric waveguide 11 has a triangular tapered structure in which an end portion (several hundred nanometers in length) on a side in proximity to the mode converter 12 becomes thinner toward the distal end. The tapered structure is not limited to a triangular shape, and may have a round distal end or a trapezoidal shape with a distal end serving as an end surface.

As a material of the dielectric waveguide 11, an optical waveguide material such as Si, SiN, or TiO₂ is used. Although the upper portion of the dielectric waveguide 11 is an air layer, a material having a refractive index lower than that of the material of the dielectric waveguide 11 may be used. By changing the material of the dielectric waveguide 11, the wavelength to be operated can be set from visible to infrared.

In the mode converter 12 and the MIM waveguide 13, a metal serving as a plasmonic material such as Au, Ag, Cu, or Pt is used for the metal layer, and an insulator such as SiO₂ or Al₂O₃ is used for the insulator layer.

The mode converter 12 includes extending portions 12a and 12b on both sides with respect to the propagation direction of the light of a core portion 12c through which the light is guided. The one extending portion 12a includes a first metal layer 121 and an insulator layer 122 in order from the lower layer. The other extending portion 12b includes an insulator layer 122 and a second metal layer 123 in order from the lower layer.

An input part (hereinafter, referred to as an “input part”) 12d of an MIM structure (described later) in the mode converter 12 is in proximity to the distal end portion of the tapered structure of the dielectric waveguide 11. The one extending portion 12a and the other extending portion 12b extend so as to sandwich the dielectric waveguide 11 on the input part 12d side of the mode converter 12.

Here, one side surface of the tapered structure of the dielectric waveguide 11 and a side surface (input-side side surface) 12f of the first metal layer 121 and the insulator layer 122 in one extending portion 12a on the input part 12d side are in proximity to each other. As similar to this, the other side surface of the tapered structure of the dielectric waveguide 11 and the side surface (input-side side surface) 12g of the insulator layer 122 and the second metal layer 123 in the other extending portion 12b on the input part 12d side are in proximity to each other.

An interval (hereinafter, referred to as “narrow gap”) between the side surface of each tapered structure and the side surfaces 12f and 12g of the extending portions 12a and 12b is preferably 20 nm or more and 40 nm or less, and may be 1 nm or more and 100 nm or less.

The side surface of each tapered structure and the side surfaces 12f and 12g of the extending portions 12a and 12b are substantially parallel to each other. Here, “substantially parallel” only needs to be such that light (side lobes of guided light of the dielectric waveguide 11) is confined in the narrow gap, and for example, the width of the narrow gap may be 10 nm on the proximal end side and 40 nm on the distal end side of the tapered structure.

Here, it has been reported that the Si fine wire waveguide and the lateral MIM waveguide through which light propagates in the TE mode can be coupled with high efficiency even when the metal film is a thin film having a thickness of several tens of nanometers by introducing a narrow gap between metal layers in the MIM waveguide using a lateral tapered structure in the Si fine wire waveguide (Patent Literature 1). Therefore, it is considered that the TE mode light propagating through the narrow gap between the side surface of the above-described tapered structure and the side surfaces 12f and 12g of the extending portion can be highly efficiently coupled to the lateral MIM waveguide structure (described later).

In the mode converter 12 and the MIM waveguide 13, for example, a thickness t₁ of the first metal layer 121 is 50 nm, a thickness t₂ of the insulator layer 122 is 10 nm, and a thickness t₃ of the second metal layer 123 is 50 nm, but the thicknesses are not limited thereto. It is only necessary to operate as an MIM structure (waveguide).

Furthermore, the position in the perpendicular direction (vertical direction) of the metal layer 123 in each of the other extending portion 12b and the core portion 12c of the mode converter 12 is determined by the thickness t₂ of the insulator layer 122, but may be in a range that can be coupled with the mode of light in the dielectric waveguide 11.

As illustrated in FIGS. 2A and 2B, one extending portion 12a and the other extending portion 12b of the mode converter 12 are arranged on each side of the dielectric waveguide 11 arranged on the input part 12d side.

In the one extending portion 12a, the first metal layer 121 and the insulator layer 122 are sequentially arranged on the SiO₂ substrate 10. In the other extending portion 12b, the insulator layer 122 and the second metal layer 123 are arranged in order on the SiO₂ substrate.

Here, as the dielectric waveguide 11 approaches the mode converter 12, one extending portion 12a and the other extending portion 12b approach each other according to the tapered structure of the dielectric waveguide 11.

As illustrated in FIGS. 2A and 2C, in the mode converter 12, one extending portion 12a and the other extending portion 12b are arranged around the core portion 12c.

Specifically, the insulator layer 122 is arranged continuously from the upper surface of the first metal layer 121 of one extending portion 12a to the other extending portion 12b. Further, the second metal layer 123 is arranged on the upper surface of the insulator layer 122 continuously from the one extending portion 12a to the other extending portion 12b.

Here, an example in which the entire upper surface of the first metal layer 121 is covered with the insulator layer 122 having the thickness t₂ has been described, but the insulator layer 122 may be arranged only in a portion sandwiched with the second metal layer 123. Although the example in which the insulator layer 122 having a thickness of t₂ is arranged on the entire lower surface of the second metal layer 123 has been described, the insulator layer 122 may be arranged only in a portion sandwiched with the first metal layer 121.

The thickness t₂ of the insulator layer 122 in one extending portion 12a, the thickness t₂ of the insulator layer 122 in the other extending portion 12b, and the thickness w_{d} of the insulator layer 122 sandwiched between the first metal layer 121 and the second metal layer 123 in the core portion 12c may be different from each other.

As described above, in the mode converter 12, the insulator layer 122 is arranged continuously from at least a part of the upper surface of the first metal layer 121 of one extending portion 12a to at least a part of the other extending portion 12b. Further, the second metal layer 123 is arranged on at least a part of the upper surface of the insulator layer 122 continuously from at least a part of the one extending portion 12a to at least a part of the other extending portion 12b.

In other words, the insulator layer 122 is arranged between the side surface of the first metal layer 121 of one extending portion 12a and the second metal layer 123 of the other extending portion 12b, and a lateral MIM waveguide structure (hereinafter, also referred to as a “lateral MIM structure”) is formed. Here, in the insulator layer 122, a region sandwiched between the side surface of the first metal layer 121 and the second metal layer 123 is the core portion 12c.

Furthermore, the insulator layer 122 is arranged between the upper surface of the first metal layer 121 of one extending portion 12a and the second metal layer 123 of the other extending portion 12b, and a vertical MIM waveguide structure (hereinafter, also referred to as a “vertical MIM structure”) is formed.

As a result, the light propagates through a region sandwiched between the first metal layer 121 and the second metal layer 123 in the insulator layer 122, that is, a region where the MIM structure (the lateral MIM structure and the vertical MIM structure) is formed.

Here, the region where the insulator layer 122 is sandwiched between the upper surface of the first metal layer 121 and the second metal layer 123 increases in a predetermined region (length: l₂) from the input part 12d toward an output part 12e.

For example, the width wₘ of the second metal layer 123 arranged in the horizontal direction from the core portion 12c to the one extending portion 12a is o at the input part 12d, and increases in a predetermined region (length: l₂) toward the output part 12e. Here, wₘ in the input part 12d may have a predetermined width other than 0. In addition, in this region, the width w_{d} of the insulator layer 122 in the lateral MIM structure may be constant or may change.

In addition, from the end of the predetermined region (length: l₂) to the output part 12e (length: l₃), wₘ and w_{d} are constant, and the width w of the MIM waveguide 13 is wₘ-w_{d}.

As illustrated in FIGS. 2A and 2D, the MIM waveguide 13 is connected to the output part 12e of the mode converter 12. The MIM waveguide 13 includes a first metal layer 121, an insulator layer 122, and a second metal layer 123 in order from the lower layer, and has a configuration with a width w of about 30 nm.

As described above, in the mode converter 12 according to the present embodiment, the insulator layer 122 continuously covers a part of the upper surface of the substrate 10, and a part of the side surface and a part of the upper surface of the first metal layer 121, and the second metal layer 123 continuously covers from a part of the insulator layer 122 covering the upper surface of the substrate 10 to a part of the insulator layer 122 covering the first metal layer 121. Furthermore, in the mode converter 12, the region in which the insulator layer 122 is sandwiched between the first metal layer 121 and the second metal layer 123 increases in a predetermined region from the input part 12d toward the output part 12e, the input part 12d approaches the distal end portion of the tapered structure, and the side surfaces 12f and 12g on the input part 12d side approach the side surfaces of the tapered structure of the dielectric waveguide 11 in substantially parallel.

### Operation of Mode Converter and Mode Conversion Device

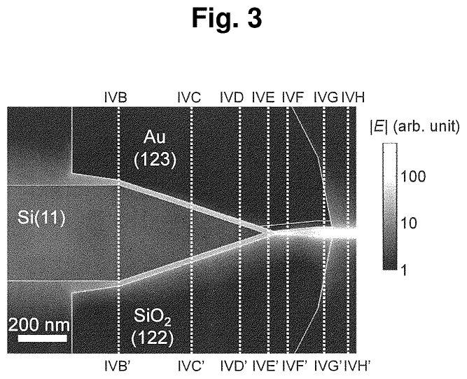

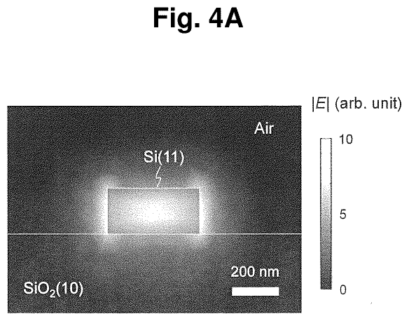

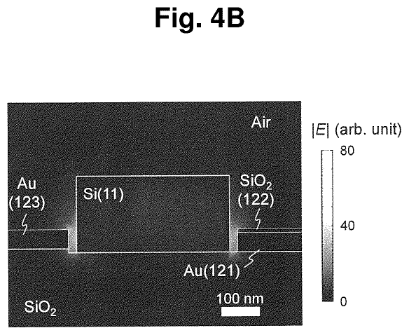

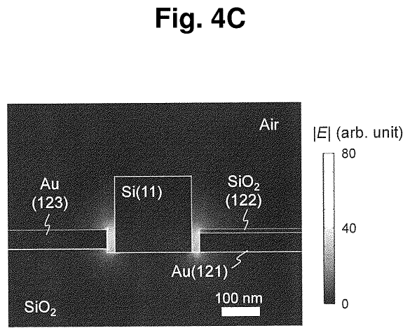

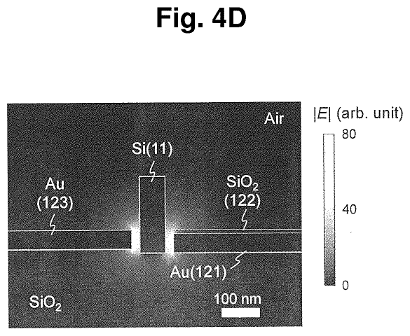

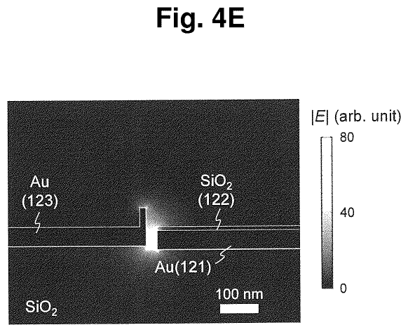

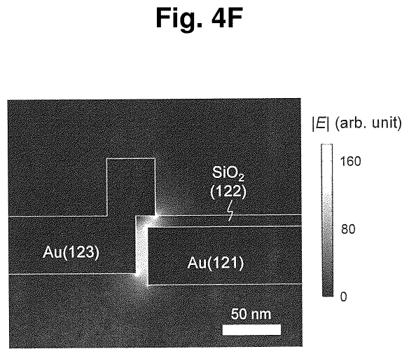

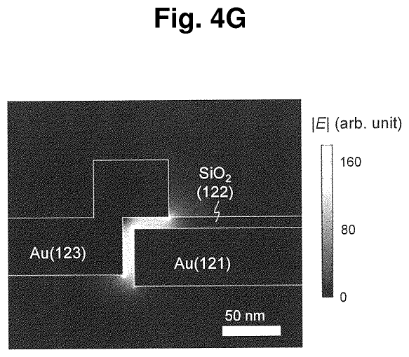

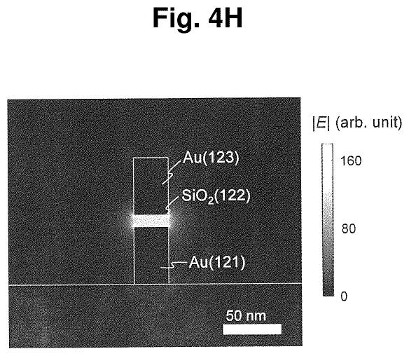

Operations of the mode converter and the mode conversion device according to the present embodiment will be described with reference to FIGS. 3 to 4H.

FIGS. 3 to 4H illustrate calculation results of modes of light propagation in the mode converter 12. The calculation was performed using a finite element method, and the wavelength of the propagation light was set to 1550 nm.

FIG. 3 is a light intensity distribution on a horizontal plane of the center height of the vertical MIM structure in the one extending portion 12a of the mode converter 12.

FIG. 4A is a light intensity distribution in a cross section of the dielectric waveguide 11, and FIGS. 4B to 4H are light intensity distributions in cross sections of IVB-IVB′, IVC-IVC′, IVD-IVD′, IVE-IVE′, IVF-IVF′, IVG-IVG′, and IVH-IVH′, respectively. In FIGS. 3 to 4H, the higher the light intensity, the whiter the color, and the lower the light intensity, the darker the color.

Here, the dielectric waveguide 11 includes a Si fine wire waveguide having a core size of 400 nm×200 nm on a SiO₂ substrate, and a length l₁ of the tapered structure of the distal end portion is 600 nm.

The metal layers 121 and 123 and the insulator layer 122 in the mode converter 12 and the MIM waveguide 13 are made of Au and SiO₂, respectively, the thicknesses t₁ and t₃ of the metal layers (Au) 121 and 123 are 50 nm, and the thickness t₂ of the insulator layer (SiO₂) 122 is 10 nm. The width w of the MIM waveguide 13 is 30 nm. l₂ and l₃ in the mode converter 12 are 160 nm and 60 nm, respectively.

The narrow gap width g between the side surface of the tapered structure of the dielectric waveguide 11 and the side surfaces 12f and 12g of the extending portions 12a and 12b of the mode converter 12 is 20 nm.

As illustrated in FIG. 3, light propagating through the mode converter 12 is distributed from a narrow gap in proximity to the tapered structure of the dielectric waveguide 11 to the MIM waveguide 13 via the mode converter 12.

As illustrated in FIG. 4A, light propagating through the Si fine wire waveguide of the dielectric waveguide 11 is distributed in the center portion of the waveguide and has side lobes in the TE mode. The side lobes couple to the lateral MIM structure via a narrow gap, as shown below.

Next, the light localized in the narrow gap gradually approaches the tapered structure of the dielectric waveguide 11 (FIGS. 4B-D).

Next, the propagating light is highly efficiently coupled to the lateral MIM structure formed by the first metal layer 121, the insulator layer 122, and the second metal layer 123 in the horizontal direction (lateral direction) (FIG. 4E). Here, the height positions of the first metal layer 121 and the insulator layer 122 of one extending portion 12a and the height position of the second metal layer 123 of the other extending portion 12b are different.

Next, as the width wₘ of the second metal layer 123 arranged in the horizontal direction from the core portion 12c to the one extending portion 12a increases, the propagating light is confined in the lateral MIM structure and the vertical MIM structure, polarized waves are mixed, and the polarization direction rotates (FIG. 4F-G).

Finally, light is introduced into the MIM waveguide 13 (FIG. 4H). At this time, the conversion efficiency in the mode converter 12 is −2.2 dB, and high conversion efficiency is achieved with a very short mode converter length.

Here, l₁, l₂, and l₃ that determine the mode converter length require a predetermined length for conversion, but in the plasmonic waveguide, mode conversion can be performed with a very short length, so that a highly efficient converter that minimizes absorption by metal can be achieved.

The optimum values of l₂ and l₃ of the mode converter 12 vary depending on the core size of the MIM waveguide 13 to be coupled, and the like. For example, for the core of the waveguide portion of t₁=50 nm, t₂=40 nm, and w=100 nm, the conversion efficiency is −1.7 dB at l₂=160 nm and l₃=180 nm.

In addition, in the present embodiment, by increasing the thickness t₁ of Au, it is possible to further improve the coupling efficiency while there is a possibility that the difficulty of fabrication increases.

As described above, in the mode converter and the mode conversion device according to the present embodiment, the TE mode light in the dielectric waveguide 11 is coupled to the lateral MIM structure of the mode converter using the lateral tapered structure, and the vibration direction of the electric field is converted into vertical light by the mode conversion mechanism between the lateral MIM structure and the vertical MIM structure. This light is introduced into the vertical MIM waveguide with high efficiency.

### Modification 1

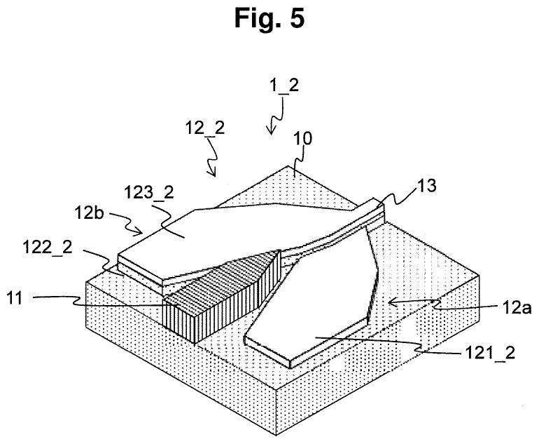

As illustrated in FIG. 5, the mode conversion device 1_2 according to the present modification includes a dielectric waveguide 11, a mode converter 12_2, and an MIM waveguide 13.

In the mode converter 12_2, a second metal layer 123_2 on the surface of the other extending portion 12b has no step. Further, an insulator layer 122_2 is disposed only immediately below the second metal layer 123_2 in the one extending portion 12a. Here, the insulator layer 122_2 may extend onto the first metal layer 121_2. The other configurations are the same as those of the first embodiment.

In the mode converter 12_2, when t₁=50 nm, t₂=10 nm, and w=30 nm, the coupling efficiency becomes −1.8 dB, and higher efficiency can be achieved.

### Modification 2

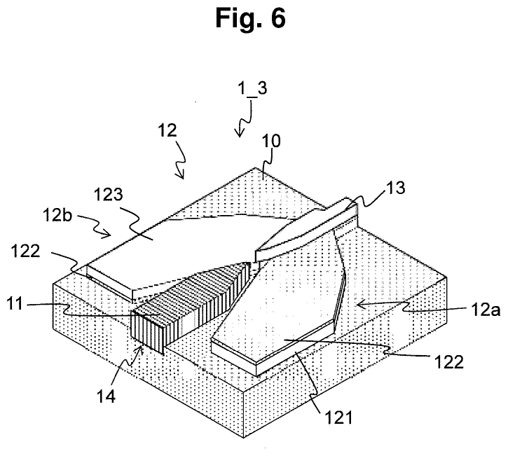

As illustrated in FIG. 6, the mode conversion device 1_3 according to the present embodiment includes a dielectric waveguide 11, a mode converter 12, and an MIM waveguide 13, and the dielectric waveguide 11 is embedded in a groove structure 14 of the SiO₂ substrate 10. The other configurations are the same as those of the first embodiment.

For example, a structure in which the dielectric waveguide 11 is embedded in the groove structure 14 is formed by depositing SiO₂ on the SiO₂ substrate 10 around the dielectric waveguide 11 after the dielectric waveguide 11 is installed on the SiO₂ substrate 10. Thereafter, the mode converter 12 and the MIM waveguide 13 are formed on the deposited SiO₂, and the mode conversion device 1_3 is manufactured.

The propagation mode of the dielectric waveguide 11 has a strong electric field near the center of the waveguide core. Therefore, with this configuration, on the input part 12d side of the mode converter 12, the positions of the first metal layer 121 of one extending portion 12a and the second metal layer 123 of the other extending portion 12b are close to the center of the dielectric waveguide 11 in the perpendicular direction (vertical direction), and thus, further improvement in coupling efficiency can be expected.

In addition, since the flatness is improved by embedding the dielectric waveguide 11, it is possible to improve and simplify the accuracy of the process when manufacturing the MIM waveguide 13 and the mode converter 12 after manufacturing the dielectric waveguide 11. In addition, a further effect is obtained by increasing the number of portions to be embedded and improving the flatness.

### Modification 3

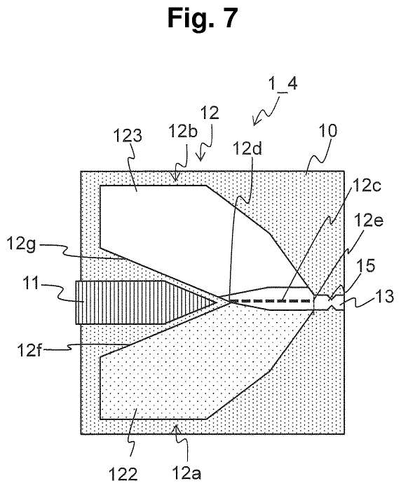

As illustrated in FIG. 7, a mode conversion device 1_4 according to the present embodiment includes a dielectric waveguide 11, a mode converter 12, and an MIM waveguide 13, and includes a size reduction mechanism 15 between an output part 12e of the mode converter 12 and the MIM waveguide 13. The other configurations are the same as those of the first embodiment.

In the size reduction mechanism 15, the waveguide width is narrower than the width of the waveguide (light propagation region) at the output part 12e of the mode converter 12 and the waveguide width of the MIM waveguide 13.

With this configuration, the electric field concentrates in the region where the light propagates, so that the electric field enhancing effect can be further enhanced.

### Second Embodiment

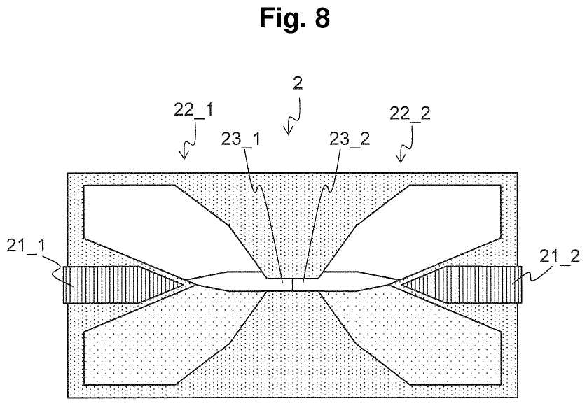

An optical device according to a second embodiment of the present invention will be described with reference to FIG. 8.

### Configuration of Optical Device

An optical device according to the present embodiment includes a dielectric waveguide, a mode converter, and an MIM waveguide, and the MIM waveguide includes an optical function device. The other configurations are the same as those of the first embodiment.

The optical function device is an ultra-compact optical function device, and for example, a light emitting element, an optical switch, an optical modulator, an optical receiver, and the like are configured by embedding an optical function substance (gain medium, absorption medium, non-linear optical medium, electro-optic effect medium, and the like) inside a core (insulator layer) of the MIM waveguide.

In the mode conversion device according to the first embodiment, since the thickness of the core (insulator layer) in the vertical MIM waveguide can be reduced, light is strongly confined in the core, and the interaction between light and a substance is greatly enhanced. In particular, by setting the thickness of the core to a single atom thickness or more and about 10 nm or less, the interaction between light and a substance is further greatly enhanced.

Therefore, if the mode conversion device according to the first embodiment is used as a platform and the configuration thereof is used for an optical device, light can be introduced into the vertical MIM waveguide with high efficiency by the mode converter, and thus light and an optical functional substance can strongly interact with each other in the MIM waveguide.

The substance to be interacted is, for example, a nanomaterial. A structure in which the insulator of the core is directly replaced with the optical functional substance or a structure in which the optical functional substance is sandwiched between the metal and the insulator may be used.

If the element structure in the optical device according to the present embodiment is made similar to the structure (for example, FIG. 1) in the first embodiment, the element structure can be used in an optical device that requires only light input or light output.

If the element structure in the optical device 2 is configured such that a dielectric waveguide 21_1, a mode converter 22_1, an MIM waveguide 23_1, an MIM waveguide 23_2, a mode converter 22_2, and a dielectric waveguide 21_2 are connected in order as illustrated in FIG. 8, the element structure can be used for an optical device such as an optical switch that requires input and output of light.

Since the distance between two metals constituting the MIM waveguide can be very short, a large electric field effect can be obtained, and an optical function device utilizing this can also be configured.

It is also possible to introduce complex structures in the core of the MIM waveguide. A structure directly coupled to the MIM waveguide can be achieved by forming a lower layer metal of the vertical MIM waveguide, forming an optical element thereon, and further forming an upper layer metal thereon.

As described above, in the optical device according to the present embodiment, since the interaction between the optical functional substance and light is enhanced, the performance of the optical device such as the light emitting element, the optical switch, the optical modulator, and the optical receiver can be improved.

In the embodiment of the present invention, an example has been described in which, in the mode converter and the MIM waveguide, the same metal layer is used for the upper metal layer (second metal layer) and the lower metal layer (first metal layer), but the present invention is not limited thereto, and different metal layers may be used. It is sufficient that the output part of the mode converter and the input part of the MIM waveguide are optically coupled.

In the embodiment of the present invention, the upper portion as the air layer may be covered with a low refractive material such as SiO₂, and deterioration of the material due to oxidation or the like can be suppressed. The insulator layer in the MIM waveguide can be replaced with Si, Ge, InP, or the like, which is a general semiconductor, and can be extended and used for a metal-dielectric-metal (MDM) waveguide.

The embodiment of the present invention illustrates an example of a structure, dimensions, materials, and the like of each component in the configuration, manufacturing method, and the like of the mode converter, the mode conversion device, and an optical device. However, the present invention is not limited thereto. Any device may be used as long as it exhibits the functions and effects of the mode converter, the mode conversion device, and the optical device.

### Industrial Applicability

The present invention can be applied to an optical integrated circuit used in an optical communication system or an optical computer.

### REFERENCE SIGNS LIST

1 Mode conversion device
11 Dielectric waveguide
12 Mode converter
12a One extending portion
12b Other extending portion
121 First metal layer
122 Insulator layer
123 Second metal layer
13 MIM waveguide

1-7. (canceled)

8. A mode converter, comprising:
a substrate;
a first metal layer on the substrate;
an insulator layer continuously covering a part of an upper surface of the substrate and at least a part of a side surface and at least a part of an upper surface of the first metal layer; and
a second metal layer continuously covering from at least a part of the insulator layer covering the upper surface of the substrate to at least a part of the insulator layer covering the first metal layer,
wherein the mode converter is configured to receive light input from a dielectric waveguide having a tapered structure,
wherein the light is configured to propagate through a region of the insulator layer sandwiched between the first metal layer and the second metal layer,
wherein the region of the insulator layer increases in size from an input part to which the light is configured to be input toward an output part from which the light is configured to be output,
wherein the input part is proximate to a distal end portion of the tapered structure of the dielectric waveguide, and
wherein each of a side surface of the first metal layer and the insulator layer and a side surface of the insulator layer and the second metal layer on a side of the input part is parallel to and proximate to a side surface of the tapered structure.

9. The mode converter according to claim 8,
wherein the light propagating through the dielectric waveguide propagates between each of the side surface of the first metal layer and the insulator layer and the side surface of the insulator layer and the second metal layer on the side of the input part, and the side surface of the tapered structure,
wherein the light propagating through the dielectric waveguide is coupled to a lateral MIM structure in the input part, and
wherein the light propagating through the dielectric waveguide is configured to be converted into light whose vibration direction of an electric field is a vertical direction from the input part to the output part.

10. The mode converter according to claim 8, wherein a surface of the second metal layer is flat.

11. The mode converter according to claim 8, wherein the mode converter is configured to output the light to an MIM waveguide.

12. A mode conversion device comprising:
a mode converter comprising:
a substrate;
a first metal layer on the substrate;
an insulator layer continuously covering a part of an upper surface of the substrate and at least a part of a side surface and at least a part of an upper surface of the first metal layer; and
a second metal layer continuously covering from at least a part of the insulator layer covering the upper surface of the substrate to at least a part of the insulator layer covering the first metal layer,
wherein the mode converter is configured to receive light input from a dielectric waveguide having a tapered structure,
wherein the light is configured to propagate through a region of the insulator layer sandwiched between the first metal layer and the second metal layer,
wherein the region of the insulator layer increases in size from an input part to which the light is configured to be input toward an output part from which the light is configured to be output,
wherein the input part is proximate to a distal end portion of the tapered structure of the dielectric waveguide,
wherein each of a side surface of the first metal layer and the insulator layer and a side surface of the insulator layer and the second metal layer on a side of the input part is parallel to and proximate to a side surface of the tapered structure, and
wherein the mode converter is configured to output the light to an MIM waveguide;
the dielectric waveguide; and
the MIM waveguide.

13. The mode conversion device according to claim 12,
wherein the light propagating through the dielectric waveguide propagates between each of the side surface of the first metal layer and the insulator layer and the side surface of the insulator layer and the second metal layer on the side of the input part, and the side surface of the tapered structure,
wherein the light propagating through the dielectric waveguide is coupled to a lateral MIM structure in the input part, and
wherein the light propagating through the dielectric waveguide is configured to be converted into light whose vibration direction of an electric field is a vertical direction from the input part to the output part.

14. The mode conversion device according to claim 12, wherein a surface of the second metal layer is flat.

15. The mode conversion device according to claim 12,
wherein a size reduction mechanism is provided between the output part of the mode converter and the MIM waveguide, and
a width of the size reduction mechanism is narrower than a width of the insulator layer in the output part and a width of the MIM waveguide.

16. The mode conversion device according to claim 12, further comprising a substrate having a groove structure, the mode converter, the dielectric waveguide, and the MIM waveguide, wherein the dielectric waveguide is arranged in the groove structure.

17. An optical device comprising
a mode conversion device comprising:
a mode converter comprising:
a first metal layer on a substrate;
an insulator layer at least partially covering an upper surface of the substrate and a side surface and an upper surface of the first metal layer; and
a second metal layer at least partially covering a first portion of the insulator layer covering the upper surface of the substrate and a second portion of the insulator layer covering the first metal layer,
wherein the mode converter is configured to receive light input from a dielectric waveguide having a tapered structure,
wherein the light is configured to propagate through a region of the insulator layer sandwiched between the first metal layer and the second metal layer,
wherein the region of the insulator layer increases in size from an input part to which the light is configured to be input toward an output part from which the light is configured to be output,
wherein each of a side surface of the first metal layer and the insulator layer and a side surface of the insulator layer and the second metal layer on a side of the input part is parallel to and proximate to a side surface of the tapered structure, and
wherein the mode converter is configured to output the light to an MIM waveguide;
the dielectric waveguide; and
the MIM waveguide; and
an optical component.

18. The optical device according to claim 17,
wherein the light propagating through the dielectric waveguide propagates between each of the side surface of the first metal layer and the insulator layer and the side surface of the insulator layer and the second metal layer on the side of the input part, and the side surface of the tapered structure,
wherein the light propagating through the dielectric waveguide is coupled to a lateral MIM structure in the input part, and
wherein the light propagating through the dielectric waveguide is configured to be converted into light whose vibration direction of an electric field is a vertical direction from the input part to the output part.

19. The optical device according to claim 17, wherein a surface of the second metal layer is flat.

20. The optical device according to claim 17,
wherein a size reduction mechanism is provided between the output part of the mode converter and the MIM waveguide, and
a width of the size reduction mechanism is narrower than a width of the insulator layer in the output part and a width of the MIM waveguide.

21. The optical device according to claim 17, wherein the mode conversion device further comprises a substrate having a groove structure, the mode converter, the dielectric waveguide, and the MIM waveguide, wherein the dielectric waveguide is arranged in the groove structure.
